(19) United States
(12) Patent Application Publication
(10) Pub. No.: US 2005/0145770 A1
(43) Pub. Date: Jul. 7, 2005

(54) Safety support for an interior mirror of a vehicle, and support assembly method

(75) Inventors: Ignacio Marcos Primo, Burgos (ES); Alfonso Castano Bajo, Vizcaya (ES)

Correspondence Address: OSTROLENK FABER GERB & SOFFEN, 1180 AVENUE OF THE AMERICAS, NEW YORK, NY, 100368403, US

(73) Assignee: GRUPO ANTOLIN INGENIERIA, S.A.

(21) Appl. No.: 10/987,515

(22) Filed: Nov. 10, 2004

(30) Foreign Application Priority Data
Nov. 3, 2003 (EP) 03380262.0

(51) Int. Cl. G02B 26/08

(52) U.S. Cl. 248/466

(57) ABSTRACT

A safety support for an interior mirror of a vehicle, comprising a rigid bearing plate for a mirror and a frame. The bearing plate has two major surfaces, a front surface, intended for receiving the mirror, and another rear surface, which can bearing reenforcement ribs. The bearing plate is fixed to the frame such that the bearing plate with the mirror does not separate from the frame during operational use, but does separate from the frame when a force exceeding a certain threshold is exerted on the front surface of the bearing plate. The fixing allow that if a force is exerted on the mirror that could break it, the bearing plate and the mirror solidly fixed to the former can separate from the frame and move in a first direction with regard to the frame. There may also be an electric circuit integrated on the bearing plate. Also an assembly method for assembling this support.

The invention is included within the field of interior mirrors for vehicles, of the type used for being assembled on an accessory of the vehicle, and which can incorporate a light source or other additional devices. It is particularly included in the field of interior glass mirrors for vehicles, which are required to comply with current safety requirements.

### BACKGROUND OF THE INVENTION

Numerous systems for installing interior mirrors for passengers in vehicles are known, generally on accessories such as sunshades. As they are close to the passenger's head, safety standards try to prevent them from breaking when an impact is experienced, causing slivers or cutting edges which can injure the occupants.

Due to the fragility of this type of mirrors manufactured with glass, it is difficult to comply with the requirements imposed for this type of devices.

Other materials, mainly metals and plastics, have been used as alternatives for overcoming these requirements, although these also present limitations.

In the case of metal mirrors, they have the drawback of requiring a degree of finish and age and corrosion resistance, making their cost greater than that of those manufactured with other materials.

In the case of using plastic materials, quality of the image and their dimensional stability are noticeably lesser than in glass mirrors, due to the effect of the temperature changes they undergo during their use.

For these reasons, it is preferable to use glass mirrors, but assembled such that in the case of an accident, they do not break if impacted nor therefore injure the occupants.

The breaking of an interior mirror can generally occur in two manners:

By compression: the breaking is caused by forces acting directly on the mirror.

By bending: when the forces exerted on the mirror (active, reactive or inertial), bend it. When these forces occur, the mirror easily breaks due to the low flexibility of the glass forming part of its structure.

To prevent these ways of fault in glass mirrors, several types of solutions have been developed.

Many times, the same cover provided for these mirrors, either for aesthetics or design, protects them from blows; this is the case, for example, of those disclosed in United States patents U.S. Pat. No. 4,926,295, U.S. Pat. No. 4,740,028, and U.S. Pat. No. 4,378,129.

In other cases, the mirror is connected to one or several layers or plates of other materials, which, in case the glass mirror breaks, prevent the pieces from falling on the passenger, such as those disclosed, for example, in patents U.S. Pat. No. 4,988,180 and U.S. Pat. No. 5,115,346, although this latter case refers to a rear-view mirror.

However, these solutions are not satisfactory, since in the majority of cases they do not sufficiently comply with the current safety standards requiring that, in the case of an impact, the mirror should not break generating cutting edges, and furthermore, the assembly system implies design and style limitations affecting both the other functions and the aesthetics of the vehicle's interior.

### DESCRIPTION OF THE INVENTION

One object of the safety support for the interior mirror of a vehicle of the invention is to offer a support which integrates and fixes the part on which said mirror is assembled, and which serves as a rigid support and thus prevents the mirror from bending.

Another object of the invention is to make a support integrating and fixing the part in which said mirror is assembled and, in the case of the mirror being impacted, that the fixing mechanism provides little disassembly resistance and allows release of the assembly formed by the support plate and mirror. Thus, breaking thereof is prevented, moving to where it cannot injure the occupants, thus absorbing the force of impact on the mirror and preventing, therefore, breaking of the mirror.

Another object of the invention is to integrate an electric circuit for the supply or control of attached electric devices, such as the mirror lighting systems, for example, on a bearing plate comprised in the safety support, such that the electric device does not hinder movement of the bearing plate when the latter is released in the case of the mirror being impacted.

Another object of the invention is to provide a mirror and support assembly which does not visibly affect the interior design of the vehicle.

Another object of the invention is to provide a fast and easy support assembly method.

Therefore, a first aspect of the invention comprises a bearing plate for the mirror and a frame. The bearing plate has two major surfaces, a frontal surface, intended for receiving the mirror, and another back surface, and an outer edge. The frame has an interior perimeter having approximately the same shape and dimensions as the outer edge of the bearing plate, such that the bearing plate with the mirror can fit in the frame.

The assembly formed by the frame and bearing plate forms the safety support of the invention, which also comprises means for attaching the bearing plate (with the mirror) to the frame, such that the bearing plate does not separate from the frame during operational use or normal use, but does separate from the frame when a force exceeding a certain threshold is exerted on the mirror, assembled on the frontal surface of the bearing plate. Thus, when the mirror assembled on the bearing plate experiences an impact, the assembly formed by both elements can separate from the frame and move in a first direction with regard to the frame (which will be called disassembly direction) due to the effect of said force. The direction contrary to this first direction will be called assembly direction.

The term “operational use” refers to operations during which forces which are not large and which are normal during use and maintenance of the vehicle are exerted on the mirror: for example, operations such as cleaning of the mirror, its normal handling or when the user touches the mirror; in these cases, the bearing plate should not separate from the frame. The threshold must be above these possible forces during operational use.

However, in the case of an accident of the vehicle or a passenger strongly striking the mirror, for example with the head, the bearing plate should indeed be released from the frame so that the mirror, with its support, can move with no obstacles and not break. After separating from the frame, the bearing plate with the mirror would preferably be housed inside the accessory where the mirror assembly is placed, such that the total force finally exerted on the mirror does not exceed the breaking force thereof.

Said breaking force is defined in each case by the dimensions and geometry of the mirror, as well as by the mechanical properties of the glass used in its manufacture. In any case, the threshold will be such that it is ensured that the breaking stresses of the mirror will not be reached at any point with smaller forces.

The attachment between the bearing plate and the mirror must ensure joint movement of both elements, and therefore it can be carried out in different manners, being able to point out among them the injection-moulding over the plate on the mirror when said plate is manufactured with a plastic material. However, other forms of attachment, such as gluing, use of resilient lugs, etc., or other materials for the manufacture of the support plate, are not discarded.

The different figures show, with an illustrative and non-limiting character, said type of support injection-moulded over the mirror, as one of the preferred embodiments.

The manner of attachment between the bearing plate solidly fixed to the mirror and the frame and which ensures attachment of both elements during operational use, is based on a combination of a set of projections on one of the two parts (bearing plate or frame) and of a corresponding set of cavities on the other part. When the projections are introduced in the corresponding cavities, normal forces can be exerted on the mirror during operational use. However, if the force exerted on the mirror exceeds the threshold value, lower than that of the breaking force of the mirror, the gripping force provided by the combination of projections and cavities is not enough to prevent the bearing plate from separating from the frame and moving in the disassembly direction.

The gripping force occurs when, once the two components, bearing plate and frame, are located in the final working position, each projection of the bearing plate of the mirror is housed in its corresponding cavity in the frame, (or each projection of the frame in each cavity of the bearing plate), such that an interference between both parts occurs which keeps them both attached. The projections or edges of the cavities, or both, must be made such that they allow flexible deformation. This can be achieved, for example, by manufacturing them from a suitable material, such as plastic, such that they are molded with the frame and the bearing plate. However, it could also be done by means of springs, or giving a rounded shape to the projections, or by any other manner which allows flexible gripping between projections and cavities. The assembly or disassembly between both parts is carried out as a result of the flexibility of these components.

The projections and cavities are arranged in such a manner that they can be indistinctively located either on the outer edge of the bearing plate, or on the interior perimeter of the frame, which is in contact with said outer edge when the support is assembled. Thus, the cavities on the frame are located in positions corresponding to the projections on the bearing plate, such that said small projections are introduced in these cavities of the frame. It is evident that the projections could also be placed on the frame and the cavities on the bearing plate.

The projections can have different shapes, always taking into account that said shape and its dimension are going to allow controlling the force necessary for assembly, and the maximum force which the attachment will support before disassembly occurs. Rounded or wedge-shaped shapes are preferably proposed, other geometries also being possible.

The frame can be assembled on the sunshade or on another part of a vehicle by means of any fixing means, for example by using screws, tabs, etc.

This plate can incorporate a plurality of reinforcement ribs formed on its back surface to provide more rigidity to the bearing plate of the mirror.

It is also possible to include other accessories, such as a device with an electric circuit, on the back surface of the bearing plate. This circuit may consist of a rigid system formed by a printed circuit board, or else by conductor strips, for example, inserted in spaces left between the ribs on the back surface of the bearing plate. The electric device may include several electric elements, more specifically, a light source which may be located on the same plane of the bearing plate and projecting outwardly from the bearing plate.

In these cases in which the mirror is accompanied by a lighting system, the frame will preferably have at least one reflecting optical parabola for each light source. This combination of elements of the electric device and of the reflecting optical parabolas in known mirror supports can restrict the free movement of the support plate in the-case of impact, with the subsequent risk of breaking, as it is not achieved that the plate is released from the frame and moves in a disassembly direction with no obstacles. Furthermore, this interference between components hinders manufacturing in the assembly line.

For said reasons, this or these parabolas in the support of the invention are configured such that they are foldable around a hinge, being able to move from a working position, where they reflect the light from the light sources, and another open, folded position with regard to said working position. Thus, by folding the parabolas to the open position, the bearing plate with the mirror and with the light source or sources can be inserted in the frame, without there being any type of interferences between components during the assembly operation.

Likewise, in the case of impact with a force exceeding the threshold force, when the mirror and bearing plate separate from the frame and freely move in the first direction or disassembly direction, said parabolas move to their open position, rotating around their hinge without being an obstacle to the free movement of the bearing plate with the mirror and the other devices that it may carry.

In these cases in which the bearing plate also incorporates electric components or part of a circuit, the electric connectors thereof are arranged so that when the assembly on the frame is carried out, the electric connectors are automatically connected with the movement of the bearing plate in the frame, without needing to carry out subsequent operations.

On some occasions, the frame includes a cover for the mirror, which opens by folding it around a hinge, which defines an axis of rotation, including a device that turns on the lights of the mirror when this cover is opened. In that case, the electric circuit can include a circuit interruption system, with a first conductor terminal joined to the first of the poles of the interruption system, and another second conductor terminal joined to the second one of the poles of the interruption system. These two conductor terminals are located on the outer edge of the bearing plate corresponding to the side of the frame where the axis of rotation of the cover is located. A small conductor part is included on said cover, on the side of the axis of rotation of the cover, placed such that when the cover is opened, this small conductor part puts the two terminals in contact, closing the electric circuit, and current reaching the light source or sources.

Both this arrangement of the electric circuit and the location of the light sources, the foldable reflecting parabolas and the device for turning on the lights, have been arranged such that they do not obstruct the way to the separation of the bearing plate with all the elements it encompasses from the frame, and the subsequent movement of the assembly in the disassembly direction.

Therefore, the connection of the electric circuit on the back surface of the bearing plate with the general electric circuit of the automobile on the accessory where the mirror assembly is arranged should not influence said separation either, said connection being possible to consist of flaps, flexible wires or any other electric connection device not preventing the relative movement of the bearing plate with regard to the frame where it is inserted.

A second aspect of the invention is to provide a mirror assembly comprising a safety support with the previously explained features, and a mirror attached to the bearing plate.

A third aspect of the invention is an assembly method of the mirror support, which allows the quick assembly of the bearing plate together with the mirror.

Therefore, the following steps are taken:

placing the bearing plate with the mirror and other devices on the frame and pressing in the assembly direction until the plate fits in place,

fixing the assembly in its place inside the vehicle.

For those cases in which an electric system with lighting such as the one described is included the assembly, the steps of the assembly operation would be

taking the frame and opening the optical parabolas,

placing the bearing plate with the mirror and other devices on the frame and pressing in the assembly direction until the plate fits in place, carrying out the electric connection at the same time,

closing the parabolas,

connecting the electric circuit of the bearing plate to the rest of the circuit of the vehicle, and

fixing the assembly in its place inside the vehicle.

### BRIEF DESCRIPTION OF THE DRAWINGS

A series of drawings is briefly described below which help to better understand the invention and which are expressly related to an embodiment of said invention, which is presented as an illustrative and non-limiting example thereof.

FIG. 1 shows the sunshade with the mirror and frame assembled.

FIG. 2 shows a rear view of the bearing plate assembled in the frame.

FIG. 3 shows a rear view of the bearing plate and frame disassembled.

FIG. 4 shows the bearing plate in the case an electric circuit is not needed.

FIG. 5 shows a section of the plate assembled in the frame.

FIG. 6 shows a detail of a manner of attaching the bearing plate and the frame.

FIG. 7 shows a detail of the connecting mechanism of the electric circuit of the light sources.

### DESCRIPTION OF A PREFERRED EMBODIMENT OF THE INVENTION

Interior mirror assemblies of the type of those of the invention are usually placed on the sunshades, but they could be placed on another accessory or part of a vehicle, such as a headrest, for example.

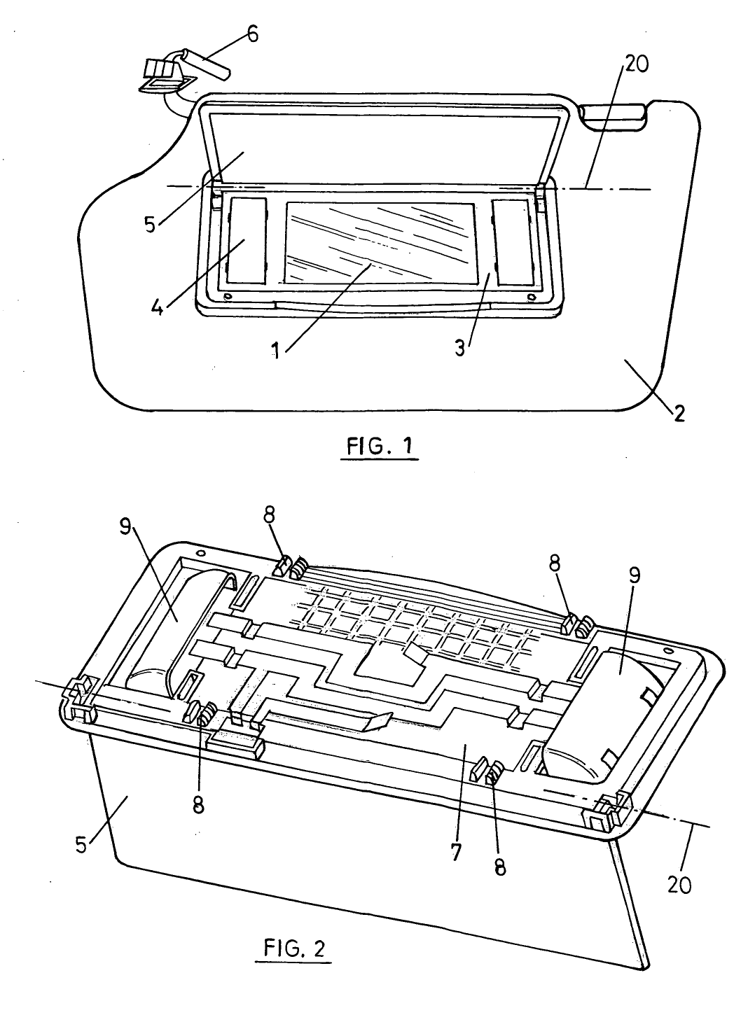

FIG. 1 shows a sunshade with the interior mirror assembly with the support of the invention. The mirror (1) is placed on a bearing plate, not visible in the operational use position, since this bearing plate is inside a sunshade (2) and under the frame (3) which, in this case, is provided with light sources (4), the corresponding electric feed circuit thereof, and a cover (5). Electric wires (6) are installed for feeding current to the light sources through the interior of the attachment swivel joint of the sunshade to the body.

FIG. 2 shows the rear part of the frame hidden inside the sunshade, with the bearing plate (7) of the mirror assembled. The frame can be coupled to the sunshade by means of any fixing means, for example by means of screws, flaps, etc. In this case, several assembly clips (8) have been arranged. The cover (5) and optical parabolas (9) reflecting the light emitted by the light sources can also be seen in this figure

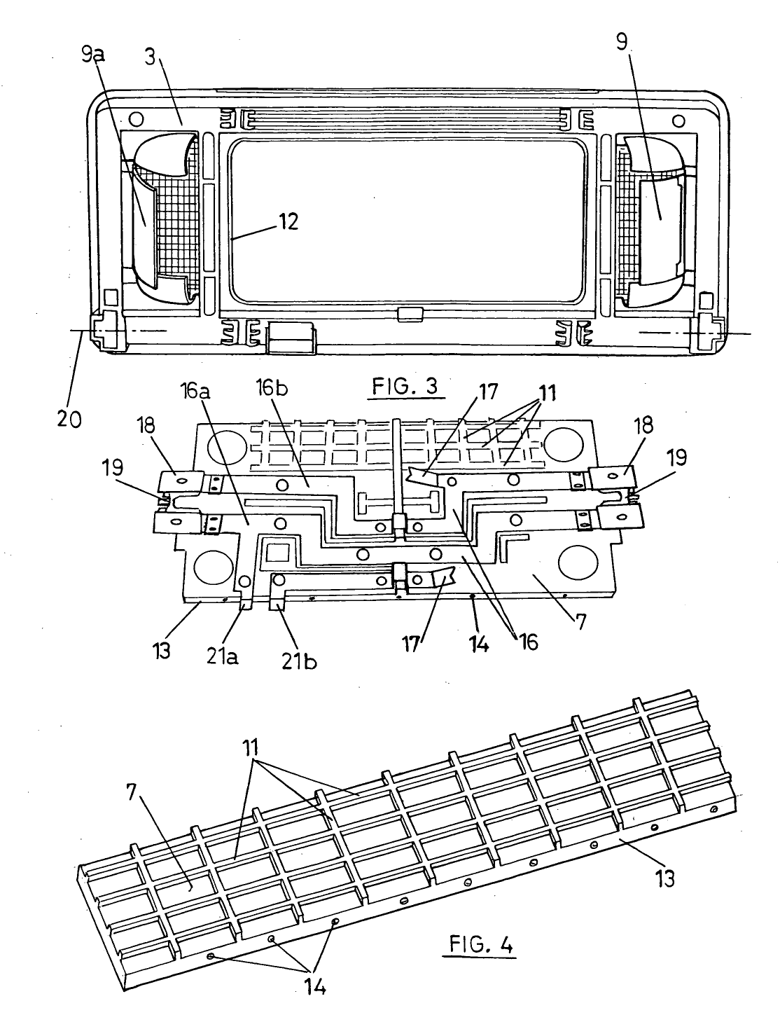

In FIG. 3, the bearing plate (7) of the mirror is disassembled from the frame (3). To separate the bearing plate (7) from the frame (3), the former must move in a first direction or disassembly direction. It will be seen below that in order to assemble the bearing plate on the frame, the parabolas (9) are opened (as the parabola (9) on the left-hand side of FIG. 3 is shown) and the bearing plate (7) is pressed against the frame in a direction contrary to the first direction or assembly direction.

One of the advantages of the support for the interior mirror of the invention is that the mirror (1) is assembled together with a bearing support (7) serving as reinforcement for the mirror. Resistance of the bearing plate can be achieved by means of the material used, thicknesses, ribs. In this case, the bearing plate has reinforcement ribs (11).

In case an electric circuit on the bearing plate is not necessary, the ribs (11) can cover the entire back surface of the bearing plate (7) in one direction and in the perpendicular direction, as can be seen in FIG. 4.

To achieve greater safety in the vehicle against impacts which the occupants may suffer against the mirror, but using a glass one rather than a metal one, the bearing plate (7) with the mirror solidly fixed to it is assembled in the frame (3) such that the bearing plate (7) does not separate from the frame (3) during operational use, but it does separate from the frame (3) when a force exceeding a certain threshold is exerted on the frontal surface of the bearing plate, i.e. on the mirror, as previously explained.

In other words, the bearing plate (7) detaches from the frame, moving in the first direction of disassembly direction (10), before the mirror (1) supports a force on it great enough for being a risk of breaking. After separating from the frame, the mirror attached to its bearing plate (7) would remain inside the accessory where the mirror assembly is placed, in this case in the sunshade (2).

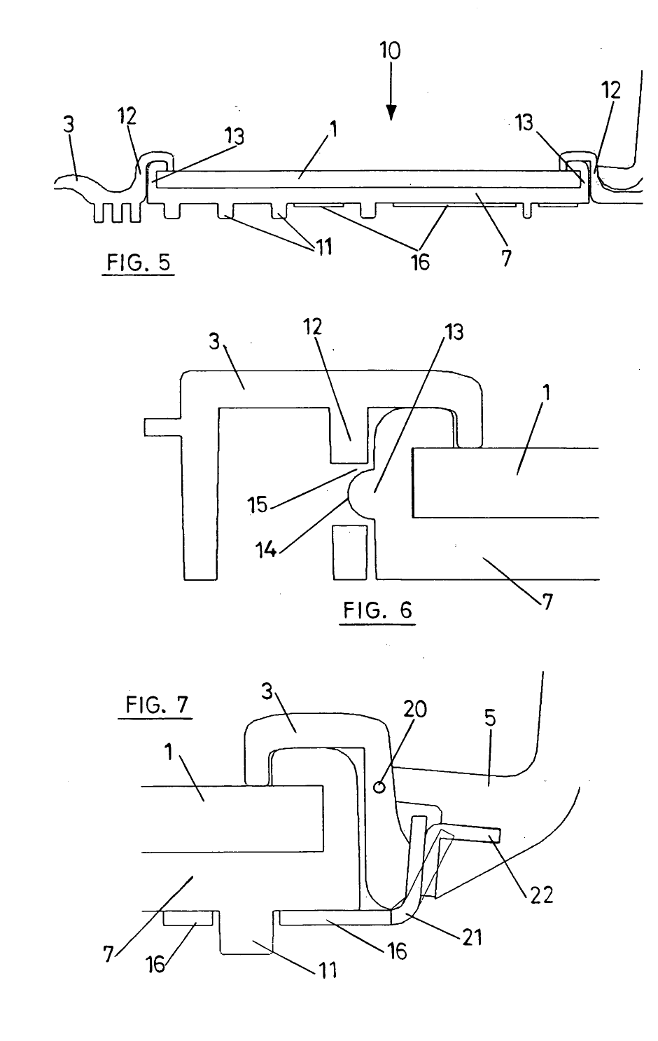

FIG. 5 shows an example of a section of a bearing plate (7) injection-moulded over the mirror (1) and assembled in the frame. It can be seen how the plate, since it is injection-moulded, covers the entire perimeter of the mirror. The relative arrangement between the bearing plate (7) and frame (3) in the assembly position can also be seen, and how the former is housed therein, the frame having a U-shaped profile with the opening in the first direction (10) or disassembly direction, and the bearing plate having a projected edge, configured such that it fits into said U-shaped edge.

As shown in FIG. 6, there are small projections (14), in this case arranged on the outer edge (13) of the bearing plate (7), and cavities (15), in this case carried out on the interior perimeter (12) of the frame (3), and in positions corresponding to the projections, which in combination fix the support plate in the frame, preventing it from becoming loose.

The pairs of small projections and cavities are arranged such that said projections (14) are introduced in these cavities (15) of the frame, such that an interference between both is generated which prevents the relative movement once the assembly is carried out, as long as it does not undergo forces exceeding the threshold, as previously defined.

In any case, the force with which the bearing plate (7) is attached to the frame (3), due to the combination of the projections (14) and the cavities (15), is enough for the bearing plate (7) not to be released from the frame (3) during operational use, but not so large that it prevents the bearing plate (7) from being released from its fixing points to the frame when the force exerted on the mirror (1) (due to an accident or a blow) exceeds the previously explained threshold in order to prevent the mirror from breaking.

Other distributions of projections and cavities could be used for attaching the bearing plate (7) to the frame (3), for example, the projections could be placed on the frame and the cavities on the bearing plate, as long as the condition that the bearing plate is released in the first direction or disassembly direction (10) due to a force exceeding the threshold is met. The only condition is that each projection, whether it is on the frame or on the bearing plate, corresponds with a cavity on the other part when both parts are assembled together.

In the case that the mirror has elements needing an electric supply, such as light sources, it is necessary for there to be an electric circuit (16), and it will optionally be placed behind the bearing plate of the mirror. This circuit must not be an obstacle for the bearing plate (7) with the mirror to be released from the frame (3) and freely moving if it experiences an impact exceeding the threshold force, since this is the main purpose of the invention.

In the case shown in FIG. 3, a mirror with an electric circuit is shown, in which the reinforcement ribs (11) have been arranged such that conductor strips (16a and 16b) forming said circuit can be placed between them. In the example shown, these strips have two connectors consisting of two conductor strip segments (17), through which the circuit (16) on the bearing plate (7) would receive electric power from the general electric circuit of the automobile through the wires (6) inside the sunshade (2). This connection, not shown, can be any of those known with as long it does not prevent the separation of the bearing plate (7) and the frame (3), being able to consist in several flaps or flexible wires or any other electric connection device not preventing the movement of the bearing plate. According to this, the arrangement would be similar if the electric device or circuit was on a printed circuit, for example, rather than conductor strips.

In the example shown, the circuit (16), made with these conductor strips, has two lamp holders (18) welded thereon wherein the light sources are placed, which in this case are two light bulbs (19) for lighting (4) the mirror. This lighting system is designed so that it turns on when the cover (5) which is over the mirror (1) is opened.

To achieve this automatic turning on the circuit (16) is interrupted at a point near the edge of the bearing plate (7) closest to the axis of rotation (20) of the cover (5). There are two conductor terminals (21a and 21b) connected to each pole projecting from the edge of the bearing plate (7) on either side of this point,.

As can be seen in FIG. 7, the cover (5) carries a small conductive part (22) on the side of the axis of rotation of the cover, such that when the cover (5) is opened that conductive part (22) puts the two previous conductive terminals (21a and 21b) in contact, closing the circuit (16) and turning on the light sources (19).

All this is arranged such that the electric connection between the part of the electric circuit incorporated in the mirror and the general circuit of the vehicle is carried out without the intervention of specific connection operations and in an automatic manner when carrying out the assembly of the support plate with the mirror, and furthermore allowing that if the bearing plate (7) of the mirror detaches from the frame (3), neither the flaps (21a and 21b) nor the cover (5) imply an obstacle for the bearing plate (7) to move in the disassembly direction (10).

The design thus carried out has the additional advantage of the mirror assembly as such, which comprises the support for the mirror and the mirror itself. The passenger sees the mirror assembly in the sunshade as it appears in FIG. 1, with the appearance of a conventional mirror assembly.

Another added advantage of this manner of connecting the bearing plate and the frame is the facility for an operator to install the mirror assembly formed by the mirror and the mirror support in the interior of a vehicle, in this case in the sunshade. To do so, the following steps would have to be taken:

taking the frame (3) and opening the optical parabolas (9), and

placing the bearing plate (7) with the mirror (1) on the frame (3) and pressing in the assembly direction until the bearing plate (7) fits, by pressure, in its position on the frame, at the same time the electric connection being carried out with the general circuit of the vehicle, and

closing the parabolas (9), and

placing the mirror assembly in a suitable area of the vehicle (in this case in a sunshade (2)), by means of suitable means, which in this case are assembly clips (8).

If the interior mirror assembly for vehicles does not need and electric circuit, the steps would be:

taking the frame (3), and

placing the bearing plate (7) with the mirror (1) on the frame (3) and pressing in the assembly direction until the bearing plate (7) fits, by pressure, in its position on the frame, and

placing the mirror assembly in this suitable area of the vehicle (in this case in a sunshade (2)), by means of suitable means, which in this case are assembly clips (8).

The materials, size, shape and arrangement of the elements will be susceptible to variation, as long as this implies no alteration of the basic concept of the invention.

Throughout the present description and claims, the words “comprise” or “include” and variations thereof, such as “comprising” or “including”, are not intended to exclude other steps or components.

1. A safety support for an interior mirror of a vehicle, comprising a bearing plate, a mirror rigidly attached to the bearing plate to be supported thereby; the bearing plate having two major surfaces including a front surface intended for receiving the mirror and a rear surface;
first attachment elements for attaching the frame for to a part of a vehicle, the frame having an open region defined by an interior perimeter;
the bearing plate having an outer edge shaped and sized to correspond with the interior perimeter of the frame; second attachment elements for attaching the bearing plate with the mirror thereon to the frame, the second attachment elements being such that the bearing plate with the mirror does not separate from the frame during operational use of the safety support, but the bearing plate does separate from the frame when a force greater than a threshold force is exerted on the front surface of the bearing plate or the mirror; and the second attachment elements enabling the bearing plate fixed to the mirror to separate from the frame and to move in a first direction with regard to the frame due to the effect of the force exceeding the threshold.

2. A safety support according to claim 1, wherein the second attachment elements for attaching the bearing plate with the mirror to the frame comprise projections on one of the bearing plate and the frame and cavities on the other of the bearing plate and the frame and corresponding with the projections, such that when the bearing plate with the mirror is fitted into the frame, each projection is housed in the respective corresponding cavity, the projections and the cavities attaching the bearing plate with the mirror on the frame during operational use.

3. A safety support according to claim 2, wherein the projections for attaching the bearing plate with the mirror to the frame are located on the outer edge of the bearing plate, and the corresponding cavities are located on the interior perimeter of the frame.

4. A safety support according to claim 2, wherein the projections for attaching the bearing plate with the mirror to the frame are located on the interior perimeter of the frame, and the corresponding cavities are located on the outer edge of the bearing plate.

5. A safety support according to claim 1, further comprising rigidifying elements for the bearing plate on the rear of the bearing plate.

6. A safety support according to claim 5, wherein the rigidifying elements are reinforcement ribs on the bearing plate.

7. A safety support according to claim 1, further comprising at least one electric device on the rear of the bearing surface.

8. A safety support according to claim 7, wherein the at least one electric device includes at least one component; and
the ribs on the rear of the bearing plate are placed and shaped to provide respective spaces between some of the ribs where the electric device components are installed.

9. A safety support according to claim 7, wherein the electric device comprises at least one light source on the bearing plate and projecting outwardly from the front surface; and a reflecting optical parabola corresponding to each light source and placed on the frame and shaped for directing light to be used during use of the mirror, and the reflecting optical parabolas are foldable around a hinge between a working position and an open position of the parabolas.

10. A safety support according to claim 9, wherein the reflecting optical parabolas are so shaped that when in the open position the parabolas do not obstruct a path to the bearing plate for the mirror and with the elements of the electric device when the mirror and the electric device are moved during assembly until the mirror and the electric device are fixed in the frame.

11. A safety support according to claim 8, wherein the reflecting optical parabolas move from their working position to their open position if the bearing plate is released from the frame due to a force exceeding the threshold having been exerted on the mirror, and in the open position of the parabolas, the parabolas do not obstruct the path of the bearing plate with the mirror and with the elements of the electric device in moving in the first direction.

12. A safety support according to claim 7, wherein the electric circuit assembled on the bearing plate of the mirror includes two terminals placed so that when the bearing plate is fitted in the frame, the terminals contact several facing conductive contacts of a general electric circuit of the vehicle forming an electric connection, and the electric connection does not mechanically restrict the free movement of the bearing plate in the first direction.

13. A safety support according to claim 9, further comprising the frame includes a cover for the mirror, the cover having a hinge with an axis of rotation, and the cover opens by rotating around the hinge;
the electric device includes an electric supply circuit for the light sources, the circuit including an interruption of the circuit between poles, and including a first conductive terminal and a second conductive terminal, each terminal attached to a pole of the electric circuit, and the conductive terminals are placed on a side of the edge of the bearing plate corresponding to the side of the frame at which the axis of rotation of the cover is located; the cover includes a conductive part on its side of the axis of rotation, and the two conductive terminals and the conductive part are arranged such that when the cover is opened which uncovers the mirror, the conductive part places the first terminal into electric contact with said second terminal and closes the electric circuit such that electric current can reach the light sources, and the conductive terminals are arranged on the bearing plate and the conductive part on the cover of the mirror such that the terminals are not an obstacle if the bearing plate detaches from the frame and moves in the first direction.

14. A method for assembling a safety support comprising the following steps:
placing a bearing plate with a mirror thereon and an electric device components thereon on a frame
pressing the plate in a direction out of the front of the mirror and perpendicular to the surface of the mirror, until the bearing plate fits in the frame,
fixing the frame on a part of the vehicle.

15. A method for assembling a safety support assembly according to claim 14, further comprising the following steps:
moving optical parabolas located on the frame to an open position for permitting installation of the bearing plate,
placing the bearing plate with the mirror and the electric device components on the frame
pressing in a direction contrary to the direction out of the front of the mirror and perpendicular to the surface of the mirror, until the bearing plate fits in the frame,
closing the parabolas to a working position thereof for directing light from the electric device components and,
fixing the frame on a part of the vehicle.

16. A safety support according to claim 1 wherein the second attachment elements comprise a cooperating connectors on the bearing plate and the frame which are engageable in a manner such that they do not separate during operational use of the safety support but which are operative to separate when a force greater than the threshold force is exerted on the front surface of the bearing plate or the mirror.

17. A safety support according to claim 7, wherein the electric device comprises at least one light source on the bearing plate and projecting outwardly from the front surface;
a reflecting optical device at each of the light sources and placed on the frame and shaped for directing light to be used during use of the mirror.
